(19) United States
(12) Patent Application Publication
(10) Pub. No.: US 2026/0138199 A1
(43) Pub. Date: May 21, 2026

(54) CHAINSAW SHARPENING ASSEMBLY

(71) Applicant: David Makinen, Negaunee, MI (US)

(72) Inventor: David Makinen, Negaunee, MI (US)

(21) Appl. No.: 18/951,239

(22) Filed: Nov. 18, 2024

(51) Int. Cl. B23D 63/16

(52) U.S. Cl. CPC B23D 63/162; B23D 63/166

(57) ABSTRACT

A chainsaw sharpening assembly for sharpening links of a chainsaw chain includes a round file, a rotary drive tool, and a handle. The round file has a cylindrical shape with teeth on a perimeter of the round file which are oriented such that the round file is configured to remove material from a link of a chain of a chainsaw when rotated about a longitudinal axis of the round file. The rotary drive tool is configured to engage a first end of the round file and rotate the round file about its longitudinal axis. The handle defines a cavity sized to receive a second end of the round file opposite the first end.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to chainsaw sharpening apparatuses and more particularly pertains to a new chainsaw sharpening apparatus for sharpening links of a chainsaw chain via rotation of a file with a drill or similar tool.

### (2) Description of Related Art Including Information Disclosed Under 37 CFR 1.97 and 1.98

The prior art describes myriad chainsaw sharpening apparatuses which use a round file to sharpen links of a chainsaw chain. Some devices of the prior art operate to rotate a round file about its longitudinal axis with a rotary drive tool to speed up the process of sharpening the cutting links. However, the prior art fails to disclose an apparatus which includes a handle that mounts to a round file opposite a rotary drive device to facilitate securely and accurately positioning the round file as desired against a selected cutting link of the chainsaw chain.

### (h) BRIEF SUMMARY OF THE INVENTION

An embodiment of the disclosure meets the needs presented above by generally comprising a round file, a rotary drive tool, and a handle. The round file has a cylindrical shape with teeth on a perimeter of the round file which are oriented such that the round file is configured to remove material from a link of a chain of a chainsaw when rotated about a longitudinal axis of the round file. The rotary drive tool is configured to engage a first end of the round file and rotate the round file about its longitudinal axis. The handle defines a cavity sized to receive a second end of the round file opposite the first end.

Another embodiment of the disclosure includes a method of sharpening a chainsaw, which comprises securing a first end of a round file in a chuck of a rotary drive tool and positioning a second end of the round file in a cavity of a handle. A user grasps the rotary drive tool and the handle and positions the same to position teeth of the round file against a cutting edge of a link of a chain of a chainsaw. The rotary drive tool is activated to cause the round file to rotate about a longitudinal axis of the round file. The round file is thereby caused to freely rotate in the cavity of the handle, and the teeth of the round file remove material from the link.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a handle of a chainsaw sharpening assembly according to an embodiment of the disclosure.

FIG. 2 is a rear perspective view of a handle of an embodiment of the disclosure.

FIG. 3 is a front view of a handle of an embodiment of the disclosure.

FIG. 4 is a side view of a handle of an embodiment of the disclosure.

FIG. 5 is a cross-section view of a handle of an embodiment of the disclosure taken from Line 5-5 in FIG. 4.

FIG. 6 is an in-use view of an embodiment of the disclosure.

### (J) DETAILED DESCRIPTION OF THE INVENTION

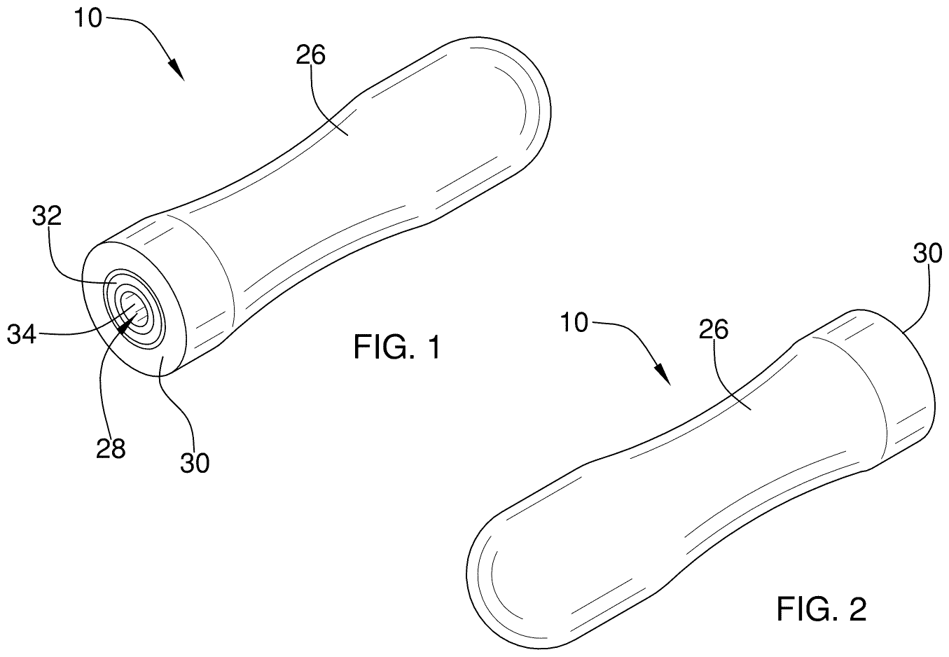

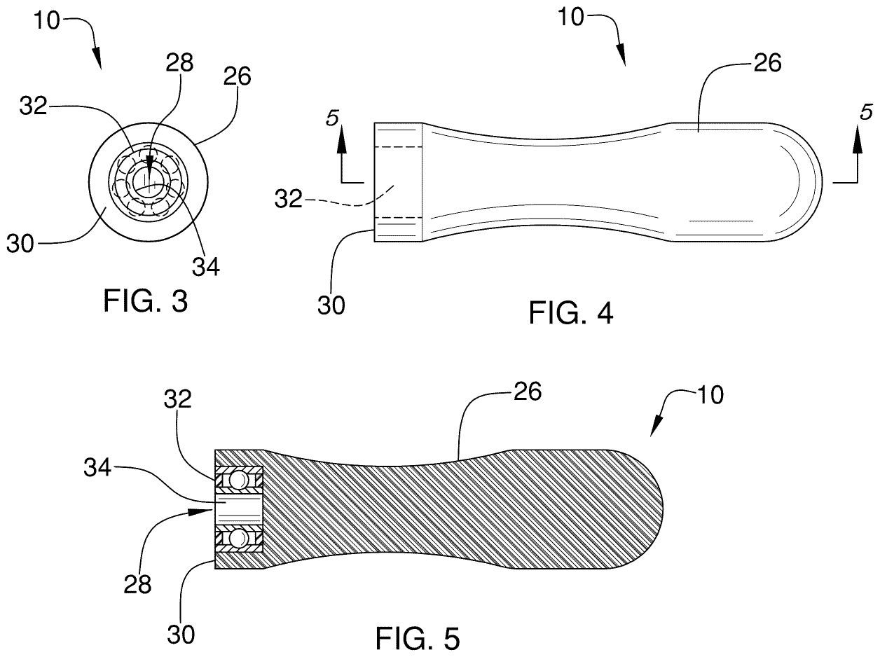

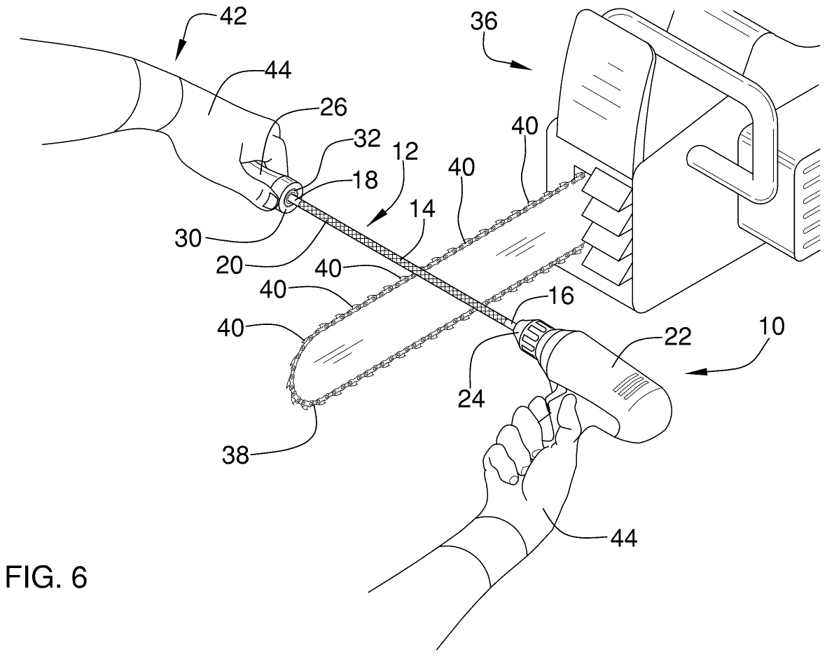

With reference now to the drawings, and in particular to FIGS. 1 through 6 thereof, a new chainsaw sharpening apparatus embodying the principles and concepts of an embodiment of the disclosure and generally designated by the reference numeral 10 will be described.

As best illustrated in FIGS. 1 through 6, the chainsaw sharpening assembly 10 generally comprises a round file 12, a rotary drive tool 22, and a handle 26. The round file 12 has a cylindrical shape and teeth 20 on a perimeter 14 of the round file 12. The teeth 20 are oriented such that the round file 12 is configured to remove material from a link 40 of a chain 38 of a chainsaw 36 when rotated about a longitudinal axis of the round file 12. For example, the teeth 20 may extend longitudinally or helically with respect to the round file 12 such that filing edges of the teeth 20 shave material off of a workpiece when the round file 12 is rotated.

The rotary drive tool 22 comprises a chuck 24 which is engageable to the round file 12 at a first end 16. The rotary drive tool 22 may be a drill, an impact wrench, or other suitable device which has a size and weight such that the rotary drive tool 22 may be held in a hand 44 of a user 42. The handle 26 is elongated and defines a cavity 28 on one end 30 which is sized to receive a second end 18 of the round file 12 opposite the first end 16.

A bearing 32 is mounted in the cavity 28 and has an inner surface 34 shaped to engage the round file 12 when inserted into the cavity 28 of the handle 26. The bearing 32 facilitates free rotation of the round file 12 with respect to the handle 26 without the file wearing against the handle 26. The inner surface 34 also aligns the longitudinal axis of the handle 26 with the round file 12 when engaging the round file 12.

In use, the round file 12 is held in the chuck 24 of the rotary drive tool 22 and the bearing 32 within the cavity 28 of the handle 26. The user 42 grasps the rotary drive tool 22 with one hand 44 and the handle 26 with another hand 44. The user 42 then positions the rotary drive tool 22 and the handle 26 such that the teeth 20 of the round file 12 abut a cutting edge of the link 40 and the round file 12 lies at a desirable angle. The rotary drive tool 22 is operated to rotate the round file 12 and remove a desired amount of material from the link 40. By continuing to hold the rotary drive tool 22 and the handle 26, the user 42 is able to accurately control the position of the round file 12 during use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chainsaw sharpening assembly comprising:
a round file having a cylindrical shape, the round file having teeth on a perimeter of the round file, the teeth being oriented such that the round file is configured to remove material from a link of a chain of a chainsaw when rotated about a longitudinal axis of the round file;
a rotary drive tool configured to engage a first end of the round file and rotate the round file about its longitudinal axis; and
a handle defining a cavity sized to receive a second end of the round file opposite the first end.

2. The assembly of claim 1, wherein the rotary drive tool comprises a chuck, the chuck being engageable to the round file at a first end.

3. The assembly of claim 1, wherein the rotary drive tool is configured to be held in a hand of a user.

4. The assembly of claim 1, wherein the rotary drive tool is a drill.

5. The assembly of claim 1, wherein the handle is elongated, the cavity being positioned on one end of the handle.

6. The assembly of claim 5, further comprising a bearing mounted in the cavity, the bearing having an inner surface shaped to engage the round file when inserted into the cavity of the handle, the bearing facilitating rotation of the round file with respect to the handle without wearing against the handle, the inner surface aligning the longitudinal axis of the handle with the round file when engaging the round file.

7. The assembly of claim 1, further comprising a bearing mounted in the cavity, the bearing having an inner surface shaped to engage the round file when inserted into the cavity of the handle, the bearing facilitating rotation of the round file with respect to the handle without wearing against the handle.

8. A chainsaw sharpening assembly comprising:
a round file having a cylindrical shape, the round file having teeth on a perimeter of the round file, the teeth being oriented such that the round file is configured to remove material from a link of a chain of a chainsaw when rotated about a longitudinal axis of the round file;
a rotary drive tool comprising a chuck, the chuck being engageable to the round file at a first end, the rotary drive tool being operable to rotate the chuck to cause the round file to rotate about its longitudinal axis, the rotary drive tool being configured to be held in a hand of a user;
a handle defining a cavity sized to receive a second end of the round file opposite the first end, the handle being elongated, the cavity being positioned on one end of the handle; and
a bearing mounted in the cavity, the bearing having an inner surface shaped to engage the round file when inserted into the cavity of the handle, the bearing facilitating rotation of the round file with respect to the handle without wearing against the handle, the inner surface aligning the longitudinal axis of the handle with the round file when engaging the round file.

9. A method of sharpening a chainsaw comprising:
securing a first end of a round file in a chuck of a rotary drive tool;
positioning a second end of the round file in a cavity of a handle;
positioning, via grasping the rotary drive tool and the handle, teeth of the round file against a cutting edge of a link of a chain of the chainsaw; and
activating the rotary drive tool, thereby causing the round file to rotate about a longitudinal axis of the round file, whereby the round file freely rotates in the cavity of the handle, whereby the teeth remove material from the link.

10. The method of claim 9, wherein the step of positioning the second end of the round file in the cavity of the handle further comprises placing the round file in engagement with a bearing mounted in the cavity.
